(19) United States
(12) Patent Application Publication
(10) Pub. No.: US 2013/0219434 A1
(43) Pub. Date: Aug. 22, 2013

(54) 3D BODY SCAN INPUT TO TV FOR VIRTUAL FITTING OF APPAREL PRESENTED ON RETAIL STORE TV CHANNEL

(71) Applicants: MEGAN MARIE FARRELL, San Diego, CA (US); Christine Mary Didonato, San Diego, CA (US); Jo Ann Crabtree, Escondido, CA (US); An-Chi Lu Campbell, Chula Vista, CA (US)

(72) Inventors: MEGAN MARIE FARRELL, San Diego, CA (US); Christine Mary Didonato, San Diego, CA (US); Jo Ann Crabtree, Escondido, CA (US); An-Chi Lu Campbell, Chula Vista, CA (US)

(73) Assignee: SONY CORPORATION

(21) Appl. No.: 13/400,441

(22) Filed: Feb. 20, 2012

(51) Int. Cl. H04N 21/482

(52) U.S. Cl. 725/60

(57) ABSTRACT

A retail store TV shopping channel may be an IPTV channel dedicated to a single retail store. 3D images of apparel items selected by a viewer of the retail store TV shopping channel are presented on the TV, overlaid on a 3D image of the viewer. Revenue is shared between the TV manufacturer and retail store.

### FIELD OF THE INVENTION

The present application relates generally to generating three dimensional (3D) body scan images that are input to an audio video display device (AVDD) such as a TV for overlaying images of apparel from a TV channel dedicated to a retail store onto the image and thus present an image of a virtual fitting on the AVDD.

### BACKGROUND OF THE INVENTION

In today's busy world it can be difficult for a person to devote time to in-person shopping, which explains much of the Internet. While online purchases are convenient, some items, such as apparel, can be difficult to buy remotely because different clothing makers use different cuts and configurations for ostensibly the same size, and may not even provide size uniformity as between competing clothing purveyors.

### SUMMARY OF THE INVENTION

Accordingly, an audio video display device (AVDD) includes a processor, a video display presenting demanded images under control of the processor, and a computer readable storage medium bearing instructions executable by the processor to present on the display a retail store shopping channel. The retail store shopping channel is affiliated with a single retail apparel company so that programs on the shopping channel are dedicated exclusively to showing apparel from the retail apparel company. The processor receives user selection of apparel presented in the retail store shopping channel and overlays a 3D image of the apparel onto a 3D image of a subject user.

The retail store shopping channel may be an Internet TV virtual channel received by the AVDD over the Internet, and if so, the virtual channel can be associated with a major channel numeral followed by a separator symbol followed by a minor channel numeral. A source of the virtual channel can be an Internet server and the channel originates from an Internet address of the server. Or, the retail store shopping channel can be sent through a source of TV signals to the AVDD.

According to detailed description below, the processor may receive a three dimensional (3D) image of the subject user. The 3D image of the subject user can be metered to indicate actual size, not just shape, of the subject user. The processor may present an image of the overlay of the 3D image of the apparel onto the 3D image of a subject user only responsive to and automatically responsive to the user selection of apparel presented in the retail store shopping channel.

In another aspect, a method includes establishing a retail store TV shopping channel presenting, on a TV, goods from only a single retail store company, and establishing a revenue sharing agreement between a manufacturer of the TV and the single retail store company.

In another aspect, a system includes a video rendering device (VRD) and a source of a retail store TV shopping channel sending signals to the VRD for presentation on the VRD. The signals are sent in an IPTV channel dedicated to a single retail store. The VRD receives user selections of apparel presented on the IPTV channel and responsive thereto presents 3D images of apparel items selected by a user of the VRD, overlaid on a 3D image of a viewer.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting example system in accordance with present principles;

FIG. 2 is a flow chart of example business logic envisioned herein, which may be implemented using computers;

FIG. 3 is a flow chart of example virtual logic;

FIG. 4 is a schematic diagram illustrating deriving a 3D computer image from a person's image;

FIG. 5 is a schematic diagram illustrating a first technique for obtaining a 3D image using passive multiple cameras;

FIG. 6 is a schematic diagram illustrating a second technique for obtaining a 3D image using an emitted light pulse;

FIG. 7 is a schematic diagram illustrating a third technique for obtaining a 3D image using laser striping;

FIG. 8 is a schematic diagram illustrating a fourth technique for obtaining a 3D image using structured lighting;

FIG. 9 is a schematic diagram illustrating a fifth technique for obtaining a 3D image using a close-fitting checkerboard or fishnet body stocking; and

FIG. 10 is a flow chart of example body stocking use logic.

### DETAILED DESCRIPTION OF THE PREFERRED EMBODIMENT

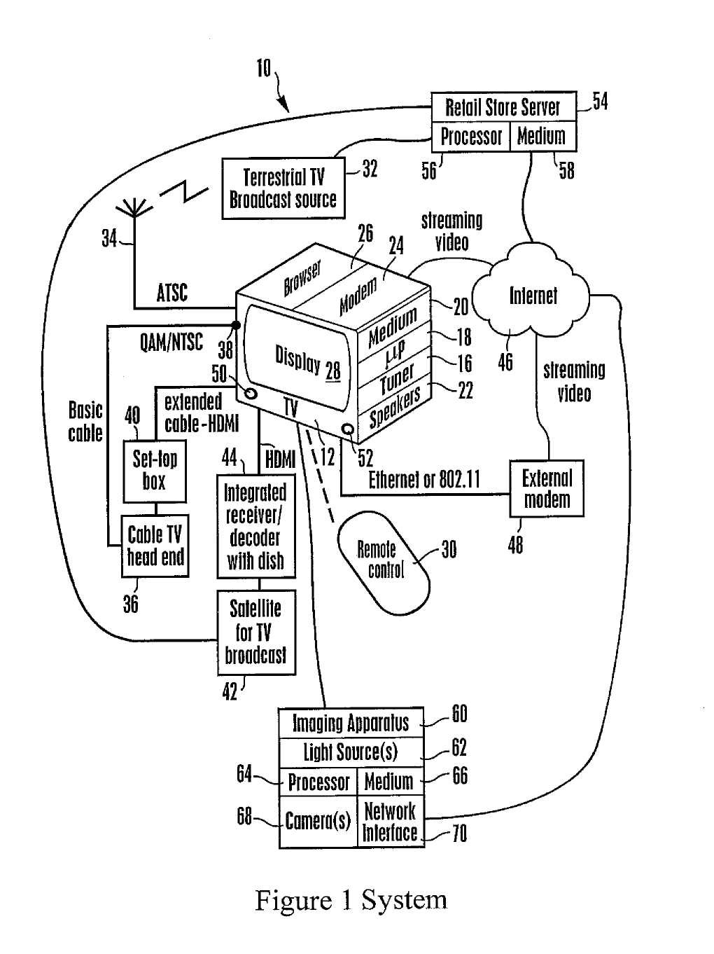

Referring initially to the non-limiting example embodiment shown in FIG. 1, a system 10 includes an audio video display device (AVDD) 12 such as a TV including a TV tuner 16 communicating with a TV processor 18 accessing a tangible computer readable storage medium 20 such as disk-based or solid state storage. The AVDD 12 can output audio on one or more speakers 22. The AVDD 12 can receive streaming video from the Internet using a built-in wired or wireless modem 24 communicating with the processor 12 which may execute a software-implemented browser 26. Video is presented under control of the TV processor 18 on a TV display 28 such as but not limited to a high definition TV (HDTV) flat panel display, and may be a touch screen display. In some implementations, in addition to the below-described gesture input mode, user commands to the processor 18 may be wirelessly received from a remote control (RC) 30 using, e.g., rf or infrared. Audio-video display devices other than a TV may be used, e.g., smart phones, game consoles, personal digital organizers, notebook computers and other types of computers, etc.

TV programming from one or more terrestrial TV broadcast sources 32 as received by a terrestrial broadcast antenna 34 which communicates with the AVDD 12 may be presented on the display 28 and speakers 22. The terrestrial broadcast programming may conform to digital ATSC standards and may carry within it a terrestrial broadcast EPG, although the terrestrial broadcast EPG may be received from alternate sources, e.g., the Internet via Ethernet, or cable communication link, or satellite communication link.

TV programming from a cable TV head end 36 may also be received at the TV for presentation of TV signals on the display 28 and speakers 22. When basic cable only is desired, the cable from the wall typically carries TV signals in QAM or NTSC format and is plugged directly into the “F-type connector” 38 on the TV chassis in the U.S., although the connector used for this purpose in other countries may vary. In contrast, when the user has an extended cable subscription for instance, the signals from the head end 36 are typically sent through a STB 40 which may be separate from or integrated within the TV chassis but in any case which sends HDMI baseband signals to the TV. Other types of connections may be used, e.g., MOCA, USB, 1394 protocols, DLNA.

Similarly, HDMI baseband signals transmitted from a satellite source 42 of TV broadcast signals received by an integrated receiver/decoder ORD) 44 associated with a home satellite dish may be input to the AVDD 12 for presentation on the display 28 and speakers 22. Also, streaming video may be received from the Internet 46 for presentation on the display 28 and speakers 22. The streaming video may be received at the computer modem 24 or it may be received at an in-home modem 48 that is external to the AVDD 12 and conveyed to the AVDD 12 over a wired or wireless Ethernet link and received at an RJ45 or 802.11x antenna on the TV chassis.

Also, in some embodiments a video camera 50, which may be integrated in the chassis if desired or mounted separately and electrically connected thereto, may be connected to the processor 16 to provide to the processor 16 video images of viewers looking at the display 28.

The TV 12 may receive content from a retail store server 54 to present the content in a shopping channel that may be dedicated to the retail store only, i.e., that may not present goods or services from any purveyor other than the retail store. Note that this can be true at least for the period of an entire program. The server typically has one or more processors 56 accessing one or more computer readable storage media 58 such as disk-based or solid state storage to source the content to the TV through, e.g., terrestrial TV communication paths as shown, and/or through satellite TV communication paths as shown, and/or through the Internet as shown in the form of a virtual (PTV) channel.

Completing the description of FIG. 1, an imaging apparatus 60 may be provided in accordance with further detailed description below which may include one or more light sources 62 such as visible or laser light sources, a processor 64 accessing a computer readable storage medium 66, and one or more cameras (imagers) 68 inputting images to the processor 64. The imaging apparatus 60 may include a network interface 70 such as a wired or wireless modem or other network interface to communicate images to, e.g., the server 54 via the Internet 46 and/or to communicate images directly to the TV 12 if desired. The imaging apparatus 60 may be embodied as a laptop computer, video game console, or even the TV 12, and the like or it may be a standalone dedicated imaging machine.

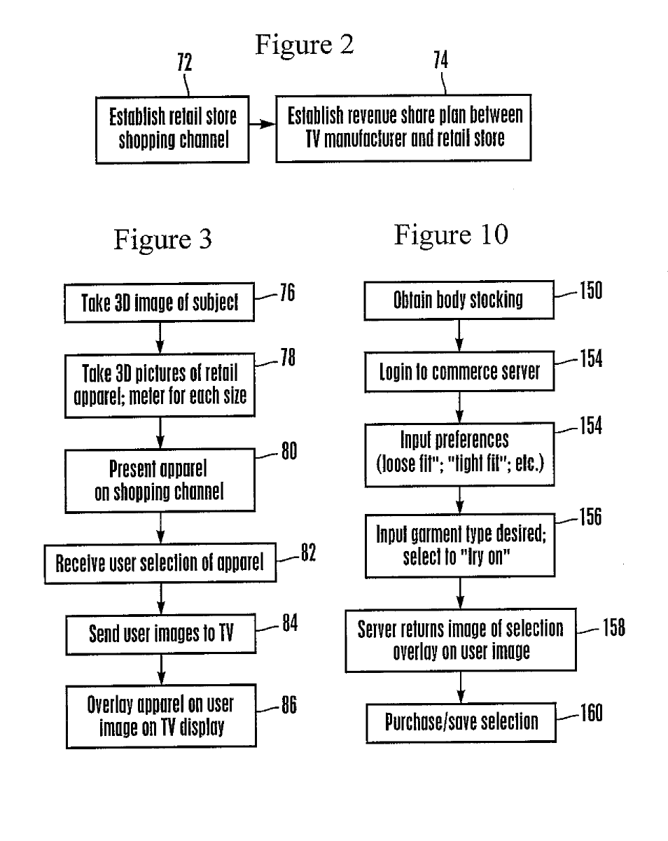

Turning now to FIG. 2, at block 72 a retail store shopping channel is established. In one implementation, the retail store shopping channel is affiliated with a single retail apparel company so that the programs on the shopping channel are dedicated exclusively to showing apparel from that retail apparel company. In example embodiments the retail store shopping channel is an Internet TV “virtual” channel received by the TV over the Internet, e.g., through the Internet modem 24. At the TV itself the virtual channel may be associated with a virtual channel number of the TV in digital format, e.g., a major channel numeral followed by a separator symbol such as a period or dash followed by a minor channel numeral. Tuning to that virtual channel causes the virtual channel content to be presented on the TV. The source of the virtual channel, however, may be the Internet server 54 and may originate from the Internet address of the server and sent to the Internet address of the TV. In other implementations, the retail store shopping channel is sent through a source of TV signals such as a satellite or cable head end.

Block 74 indicates that a revenue sharing agreement can be established between a manufacturer of the TV 12 and the retail store company. For example, for each product purchased by a user through the virtual channel, the retail store may remunerate money to the TV manufacturer. Or, the retail store may simply pay for each periodic program airing, e.g., a fixed amount for each thirty minute program segment. Yet again, the retail outlet may permit the TV manufacturer, in exchange for providing the retail store channel, to advertise for free or at discounted rates in stores owned by the retail store corporation.

Now referring to FIG. 3, commencing at block 76 a three dimensional (3D) image is taken of a subject user by means of, e.g., the imaging apparatus 60 shown in FIG. 1. Additional disclosure below sets forth various ways this may be accomplished. Preferably, the images are metered in way that indicates the actual size, not just the shape, of the subject user. The images may be uploaded to the TV 12 and/or to the retail store server 54. Note that the identification of the subject user may also be included in or otherwise associated with the image files.

In some embodiments, the logic can proceed to block 78 wherein 3D images are also taken of apparel from the retail store sought to be vended on the retail store shopping channel. These images also may be metered using, e.g., principles below, so that the absolute size, not just the shape, of both the subject user and the various apparel sought to be vended are indicated in a 3D computer image file representing the respective image. The apparel images typically can be uploaded to the retail store server 54 or other source for ultimate provisioning to the TV 12.

Block 80 indicates that the apparel is presented on the retail store shopping channel and at block 82 a user's selection of the apparel may be received by means of, e.g., the RC 30 sending a select signal to the TV to select a selector element that may be presented on the TV display as a user interface. Note that the user may also input his or her identification and this identification may be uploaded by the TV 12 to the server 54 if desired.

Block 84 indicates that the subject user 3D image is provided to the TV 12, either directly from the imaging apparatus 60 or through the retail store server 60 via the retail store shopping channel. Responsive to the user selection at block 82, at block 86 an image of the selected apparel is overlaid on the subject user image and presented on the TV. The step of overlaying may be performed at the server 54 and the composite image downloaded to the TV over the shopping channel, or the step of overlaying may be performed by the TV processor combining the subject user image with the 3D image of the selected apparel. Particularly in embodiments wherein not just the shape, but also the size, of the images of the appeal are recorded, it will be appreciated that the composite image on the TV closely reflects what the subject user would actually see in a mirror were she trying on the garment in the retail store. Note that the composite image may be presented in a small window at the corner of the shopping channel presentation or, upon selection of an item of apparel and subsequent overlay processing at block 86 may replace the shopping channel presentation in full screen view either for a period of time, e.g., thirty seconds, and/or until a user inputs a command to resume normal shopping channel presentation using, e.g., the RC 30.

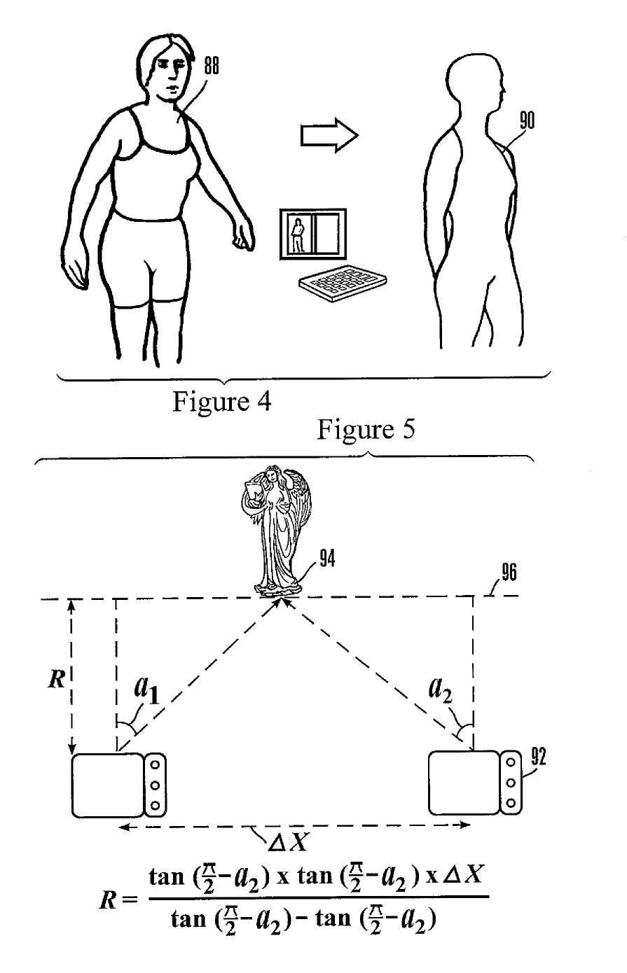

FIG. 4 illustrates that a subject user 88 may be imaged, e.g., by the imaging apparatus 60 in FIG. 1, to produce a 3D image 90 of the subject user, which is typically stored digitally.

One way to achieve the image 90 in FIG. 4 is illustrated in FIG. 5. Here, the imaging apparatus may include multiple spaced-apart cameras 92 imaging an object 94 (such as the subject user) from multiple angles simultaneously. In effect, a 3D image is generated passively (not requiring emitting light onto the object) using stereoscopy by combining the images from the cameras. To obtain absolute image size in addition to shape, the perpendicular distance “R” from the cameras 92 to a plane 96 defined by the object is calculated using the below formula and variables depicted in FIG. 5, and then the true height and width of the object can be calculated using triangulation.

R=[(tan((π/2)−α1)×(tan((π/2)−α2)×ΔX]/[(tan((π/2)−α1)+(tan((π/2)−α2)]

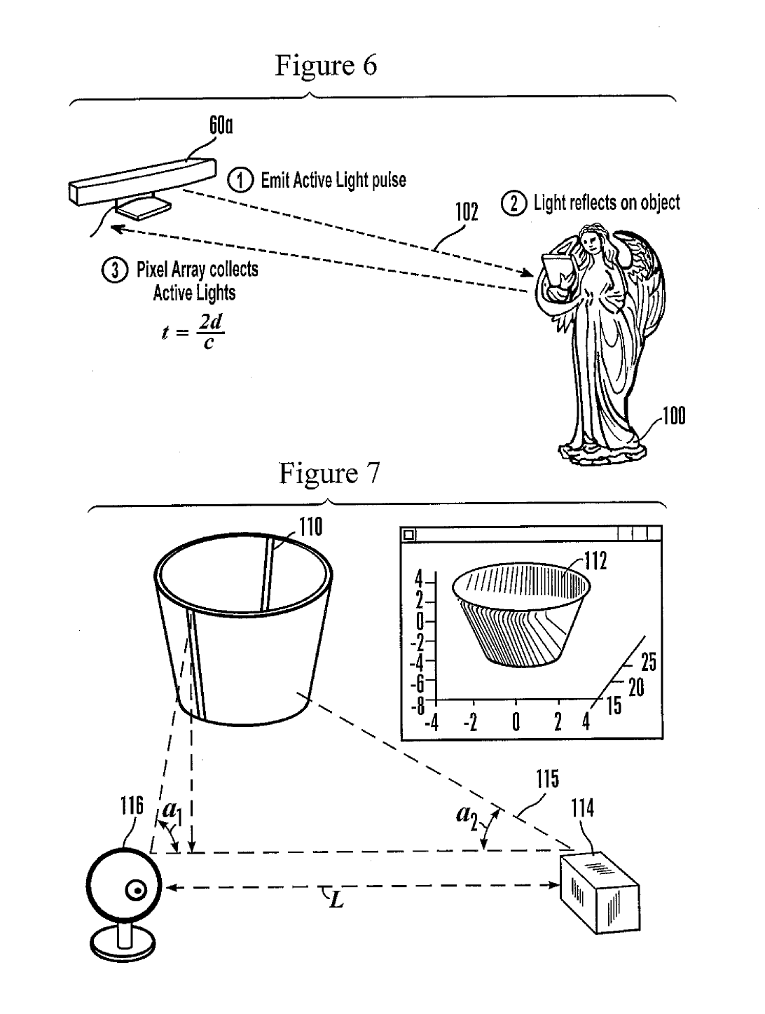

FIG. 6 illustrates another way to produce a 3D image of an object 100 such as the subject user in which an imaging apparatus 60a (which may be established by the imaging apparatus 60 in FIG. 1) emits a light pulse against the object 100 which is reflected back to and detected by the apparatus 60. The image of the object is captured and to ascertain the distance “d” between the apparatus 60a and object 100 (and, hence, to know the absolute size of the object) the time “t” between light beam emission and reflection detection at the apparatus 60a is multiplied by the speed of light and divided by two.

Yet again, FIG. 7 shows that laser striping may be used to image an object 110 (which can be the subject user) to produce a 3D image 112 of the object established by stripes with spaces therebetween. Assume that an imaging apparatus includes a laser emitter 114 scanning a laser beam 115 across the surface of the object 110, and that a camera 116 captures reflections of the laser beam to render the 3D image 112. To ascertain the true size of the object 110, the distance “R” between the camera 116 and object 110 is determined as follows, with the variables in the equation below depicted in FIG. 7.

R=L sin α1 sin α1[ sin(α1+α2)]

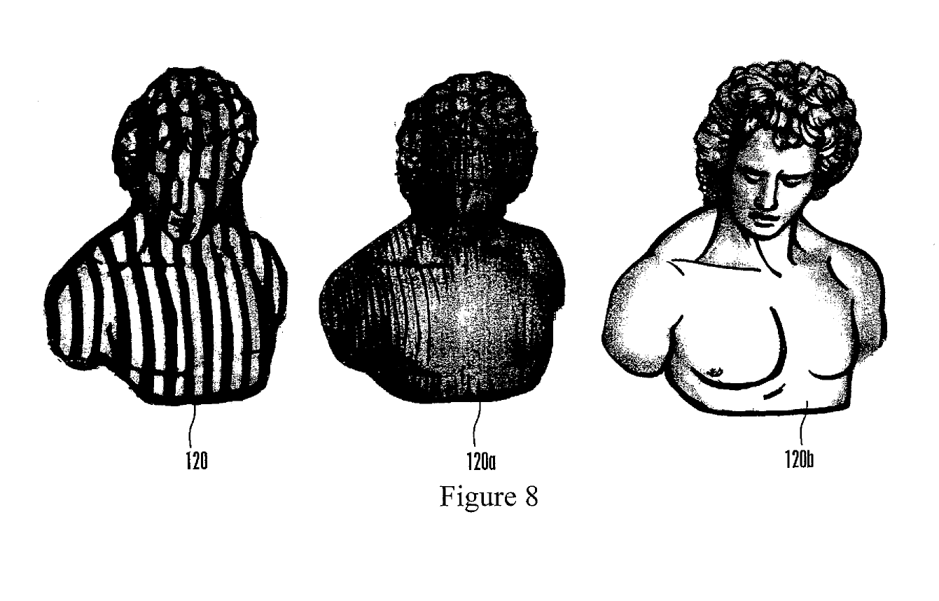

FIG. 8 shows yet another embodiment in which an imaging apparatus with two or more cameras distanced from each other and a light projector scans multiple points of an object 120 at once using visible light, which is reflected back to the camera from the object. The light is projected in a pattern, in the embodiment shown, in a pattern of vertical stripes, and deformation of the pattern in the reflection of the image is correlated to contour lines (120a) with the space between contour lines then being filled in by interpolation to render a solid 3D image (120b).

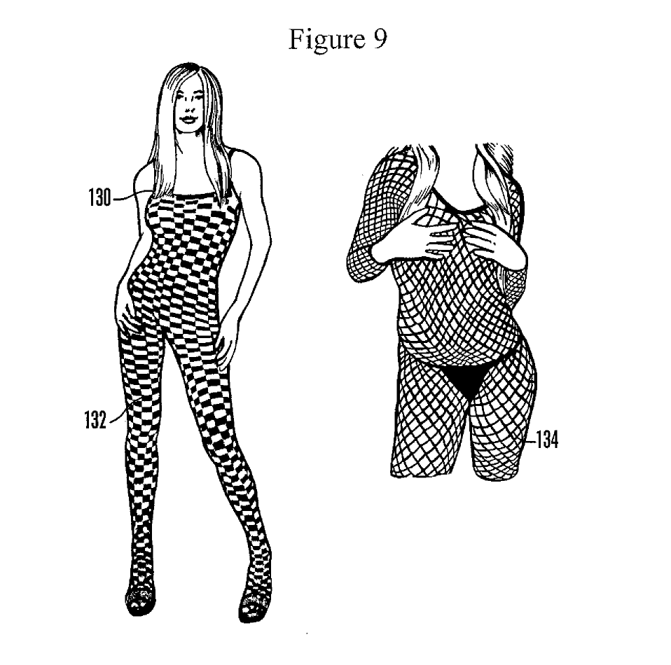

Instead of using patterned lighting, FIG. 9 shows that a subject user 130 may don a tight-finding Spandex-type checkerboard body stocking 132 or fishnet-style body stocking 134. Portions of the body stockings can be more reflective than other portions so that one or more cameras capturing an image of the subject user 130 essentially capture a contoured reflection highlighted by the reflected portions.

With more specificity, using a fixed pattern body stocking, a person can take a 3D, full 360 degree image of themselves that accurately represents the exact curvature of his or her body in order to search for and purchase clothes online. The stocking can be made as a checkered suit or a mesh suit with different color patterns. The stocking will have to come in various sizes such as L, M and Small. It will be made of flexible materials like panty hose or spandex so that it hugs the body when the user puts it on. The stocking records the data of the person's measurements. The stocking would function as a highly intelligent electronic tape measure, and would record standard body measurements (as dictated by the textile industry, e.g. ASTM, the American Society for Testing and Materials). Measurements could include head, neck circumference, chest/bust—upper, chest/bust—center, center of back, neck to cuff, back waist length, shoulder to waist, waist to floor, sleeve length, armpit to cuff, upper arm, armhole depth, waist, hip, inseam, hip to knee, knee to floor, foot to hip, foot size (length and width).

The close-fitted nature of the stocking allows for more exact anthropometric measurements. For example, whether the individual's actual stature is due to a longer leg to hip measurement or longer torso (i.e. two people that are 5′8″ will not look the same; their anthropometric measurements will differ according to bone structure, body and muscle mass, among other factors). A body stocking such as those shown in FIG. 9 with a fixed pattern which defines the surfaces and curvatures of the body takes a much more accurate measurement of an individual than current 3D image capture systems. Most 3D body scanning methods are achieved by using multiple cameras and laser beams.

Further, the body stocking can be designed in various sizes and made of stretchy materials which can hug the form of the body.

In a more detailed explanation of how the body stocking in FIG. 9 may be used, a subject user dons the body stocking over his or her nude form, and then takes a 360 degree video recording or photographic images of the front, back and side of him or herself. These images can be captured using below-described technology including MS Kinect, Playstation move, or Ray Modeler). The image is converted to 3D coordinates with the aid of the squares or fabric crossings of the body stocking as reference and then uploaded from the imaging apparatus shown in FIG. 1 to a commerce server for access thereof by the subject user upon login. The data can be accessed when the user is ready to shop for herself or another individual. Each individual can share permission to access their own 3D measurements as broadly or narrowly as they choose. Note that the measurements can be created according to industry standards (“snug fit”=x inches in the chest/bust area, etc.)

Additionally, the subject user can also provide additional preferences in clothing that can be uploaded to the commerce server, e.g., a preference for a tighter fitting top or a looser fit. The body stockings shown in FIG. 9 may be made available in retail stores for trying on by customers in the store and imaging according to description above. Or, the consumer can purchase the 3D body stocking from a number of different retailers, on-line or in-store. The body stocking would be made of material that is able to cover an entire individual from neck to ankle. In any case, once the user has transferred his or her data to the server, he or she can access this data to try on clothing or conversely, have a “personal shopper” or retailer recommend clothes based on his or her measurements and send these clothing selections to him or her digitally.

When the checkerboard pattern body stocking 132 in FIG. 9 is used, actual body dimensions can be obtained from a/series of picture(s). The camera view matrix (dimension, focal length) and dimension of each square are known. The squares preferably are equal in size and shape and small enough to be located at the same image plane as some of the other nearby squares.

If “d” is the distance between the camera and a particular square in the stocking 32 and “f” is the focal length of the camera, then the angle of view “α” from the camera to any particular square is given by:

$$∝ = {tan}^{- 1} ( \frac{d}{2 f} )$$

The 3D shape, including actual size dimensions, of the wearer of the stocking 132 is obtained by modifying the size of each square and true shape of the square as it is distorted from a true geometric square by the curvature of the person's body using the above formula. Typically, a series of images may be obtained at various angles to give a better perspective. The true 3D coordinates of each square thus can be obtained from a series of 2D image(s).

In some examples, customer information may be shared, conforming to any necessary privacy laws and allowing for customer opt-in, including how often the person shops, where he or she shops, how much he or she spends on a shopping trip and where, how often the person searches for clothing content, what they are searching for, etc., whether the person is the primary earner in the family, etc.

FIG. 10 illustrates a user case example. Assume the subject user is a woman who would like to shop for dresses online. At block 150 the body stocking is obtained, by purchase for instance, her measurements taken as described in the process above and provided to the commerce server. Proceeding to block 152 she logs into the 3D commerce system to which the 3, inputting the above-described fitting preferences (such as loose fit, tight fit, short skirt, long skirt, etc.) and then at block 156 she inputs the apparel or garment type desired. The user could also choose to limit the search to her specific desires in a dress, i.e., color, pattern, texture, etc. Proceeding to block 158 the server, using the previously captured body measurements, returns only garments that fit her specific body measurements (i.e., 36″ bust, cup size, waist, etc). The user can “drill down” the search into all of the currently available textile search terms. Through gesture commands (captured, e.g., by one of the above-described cameras), voice recognition, or visible onscreen menu driven options, the user can try on any desired piece of wardrobe and change to different colors, different fabric materials, different patterns, or different variation of sizes for that specific piece of wardrobe. The server overlays the user selection onto the user image and presents (e.g., on the TV 12 or other appliance employed by the user) a 3D presentation that can rotate onscreen to show the user the fitted garment from various angles. The user can continue to try on clothes until she finds the right dress for purchase at block 160. Or she can save her search and return to it later. If the user selects to purchase the product, she can choose to do so through the 3D commerce platform or direct from the retailer.

In addition to the above, present principles recognize that the above-described service may be sold by, e.g., the TV manufacturer in a variety of ways, each resulting in direct revenue for the company. Some illustrative examples include obtaining from a clothing retailer a desired customer segments, e.g., young adults, and screen IPTV subscribers that meet these criteria so that only prescreened individuals may subscribe to the above-described shopping channel. The commerce server, which may be owned/operated by the TV manufacturer, can scan its database of users and provide a relevant customer list based on the specifications provided by the retailer. Additional customer screening criteria include age, number of times the person searches a clothing retailer's website, people that spend over a predetermined dollar amount per visit, etc. The above principles may be implemented as a paid service model that could be monthly subscription or purchased in “bulk” or batch as the needs of the retailers change, due to season, sales, new product introductions, etc.

Furthermore, as described above a clothing retailer can choose to purchase a channel on the a TV manufacturer Entertainment Network. The retailer could then push customized and relevant content to the subscribers, including new products, promotions, in-store events, etc. If, for example, Clothing Retailer A purchased a channel, the TV manufacturer may receive two or more revenue streams including payment from Clothing Retailer A for the TV manufacturer to host the Clothing Retailer A shopping channel. Moreover, customers may be required to pay the TV manufacturer to subscribe to the Clothing Retailer A channel (monthly, etc.) Still further, Clothing Retailer A may be required to pay the TV manufacturer to advertise this service.

These above revenue streams may be in addition to a sign-up fee all users may be charged to use the 3D eCommerce service. Upon sign up to the eCommerce service, users would be presented with a variety of subscription options, for example, storage of image and use of data for sharing over social networks or to retailers, use of eCommerce platform for personal purchases, subscription to retail channels that are relevant to them, and participation in the personal shopper service.

The personal shopping experience can be augmented by allowing a user to share his or her data with third parties such as friends or retailers. Also, a business to business (B2B) model may be established in which a retail store hires e-Shoppers who review the individual preferences of a client, as well as his/her 3D image, and then execute the relevant steps in FIG. 10 above, providing a data packet of clothing selections on the customer's 3D shape back to the customer through his or her TV. At his or her leisure, the customer can browse the selection of outfits the e-Shopper has selected. A number of actions could be taken at this point, including sharing the outfits with friends and family for opinion, sending a message or questions back to the retailer about the selection (some could be done electronically, like “do you have this in black, a bigger size, etc.), selecting those items for purchase and getting the items paid for and shipped through their TV, tablet, phone, etc. For those husbands shopping for wives, or friends shopping for other friend's birthdays, a person could agree to share his or her data with another person(s) to allow them to select clothing and items for them. To make this easier on those doing the shopping, the person could utilize a “wish list”.

Without limitation, the following body scanners may be used to produce the 3D image of the subject user (note that one or more of the following product designations may be trademarked): NextEngine 3D scanner, EXAScan hand held 3D scanner, Human Solution 3D scanner, Space Vision 3D scanner, Vitronic Optical 3D scanner, TC2 Body Scanner, Skytu's Body Scanner using Kinect. Indeed, some game consoles, such as Sony's Playstation®, a subject user can take a 3D image of her body from all angles, and the image can be updated as the person may change shape owing to weight loss or gain. As described above, this image is used as the basis for clothes purchasing. This subject user can “try on” any clothes that appear in the shopping channel and that are presented for selection and will be able to see an overlay of the selected garment from 360 degrees. The subject user can thus shop on a shopping channel using her own body, as represented by the 3D image of her, as a virtual mannequin. Additionally, the subject user can via her TV contact a personal shopper, tell the shopper what her clothing needs are, and the shopper can send her a pre-packaged file of outfits that she has selected, which can be purchased over her television. In essence, the shopping channel becomes a “virtual closet” in which images of clothes can be tried on by overlaying those images onto the image of the subject user. If desired, the composite image of the subject user with overlaid garment can be stored in a database, e.g., at the server 54, and a personal shopper accessing the server 54 can assess wardrobe needs of the subject user for additional items to complement the overlaid garment.

In addition to the TV manufacturer sharing revenue with the retail store, the shopping channel may be provided to users on a subscription basis with the TV manufacturer charging users a subscription fee to access the shopping channel. Subscriber advertisements may also be shown in the channel and revenue from the advertiser shared with the TV manufacturer. In addition, present principles may facilitate social interaction by enabling a user to send composite user/garment images to social networking friends over the Internet, and using the social network the friends can indicate whether they like or dislike the user's choices. Other uses include determining in 3D what plastic surgery would look like in its end state and rendering virtual 3D pets.

While the particular 3D BODY SCAN INPUT TO TV FOR VIRTUAL FITTING OF APPAREL PRESENTED ON RETAIL STORE TV CHANNEL is herein shown and described in detail, it is to be understood that the subject matter which is encompassed by the present invention is limited only by the claims.

What is claimed is:

1. Audio video display device (AVDD) comprising:
processor;
video display presenting demanded images under control of the processor;
computer readable storage medium bearing instructions executable by the processor to:
present on the display a retail store shopping channel, the retail store shopping channel being affiliated with a single retail apparel company so that programs on the shopping channel are dedicated exclusively to showing apparel from the retail apparel company;
receive user selection of apparel presented in the retail store shopping channel; and
present on the display an overlay of a 3D image of the apparel onto a 3D image of a subject user.

2. The AVDD of claim 1, wherein the retail store shopping channel is an Internet TV virtual channel received by the AVDD over the Internet.

3. The AVDD of claim 2, wherein the virtual channel is associated with a major channel numeral followed by a separator symbol followed by a minor channel numeral.

4. The AVDD of claim 3, wherein a source of the virtual channel is an Internet server and originates from an Internet address of the server.

5. The AVDD of claim 3, wherein the retail store shopping channel is sent through a source of TV signals to the AVDD.

6. The AVDD of claim 1, wherein the processor receives a three dimensional (3D) image of the subject user.

7. The AVDD of claim 6, wherein the 3D image of the subject user is metered to indicate actual size, not just shape, of the subject user.

8. The AVDD of claim 1, wherein the processor presents an image of the overlay of the 3D image of the apparel onto the 3D image of a subject user only responsive to and automatically responsive to the user selection of apparel presented in the retail store shopping channel.

9. Method, comprising:
establishing a retail store TV shopping channel presenting, on a TV, goods from only a single retail store company; and
establishing a revenue sharing agreement between a manufacturer of the TV and the single retail store company.

10. The method of claim 9, wherein for each product purchased by a user through the retail store TV shopping channel, the retail store remunerates money to the manufacturer of the TV.

11. The method of claim 9, wherein the retail store pays for each periodic program airing on a fixed amount basis.

12. The method of claim 9, wherein the retail stores permits the manufacturer of the TV, in exchange for providing the retail store TV shopping channel, to advertise for free or at discounted rates in stores owned by the retail store.

13. The method of claim 9, wherein the retail store TV shopping channel presents 3D images of apparel selected by a viewer of the retail store TV shopping channel on a TV display showing the retail store TV shopping channel, the images of apparel being overlaid onto a 3D image of a subject user.

14. System comprising:
video rendering device (VRD);
source of a retail store TV shopping channel sending signals to the VRD for presentation on the VRD, the signals being sent in an IPTV channel dedicated to a single retail store, the VRD receiving user selections of apparel presented on the IPTV channel and responsive thereto presenting 3D images of apparel items selected by a user of the VRD, overlaid on a 3D image of a viewer.

15. The system of claim 14, wherein the VRD is an audio video display device (AVDD) comprising a processor, a video display presenting demanded images under control of the processor, and a computer readable storage medium bearing instructions executable by the processor to present on the display a retail store shopping channel.

16. The system of claim 15, wherein the retail store shopping channel is affiliated with a single retail apparel company so that programs on the shopping channel are dedicated exclusively to showing apparel from the retail apparel company.

17. The system of claim 16, wherein the processor receives user selection of apparel presented in the retail store shopping channel, and overlays a 3D image of the apparel onto a 3D image of a subject user.

18. The system of claim 15, wherein the processor receives a three dimensional (3D) image of the subject user.

19. The system of claim 18, wherein the 3D image of the subject user is metered to indicate actual size, not just shape, of the subject user.

20. The system of claim 15, wherein the processor presents an image of the overlay of the 3D image of the apparel onto the 3D image of a subject user only responsive to and automatically responsive to the user selection of apparel presented in the retail store shopping channel.
